(19) United States
(12) Patent Application Publication
(10) Pub. No.: US 2003/0074221 A1
(43) Pub. Date: Apr. 17, 2003

(54) Method for controlling and monitoring the process sequence of a telemedical healthcare service

(76) Inventors: Tilo Christ, Erlangen (DE); Heinz Prihoda, Heroldsberg (DE); Volker Schmidt, Erlangen (DE); Siegfried Schneider, Erlangen (DE); Hans-Dieter Schuell, Weisendorf (DE); Werner Striebel, Schwarzenbruck (DE); Gudrun Zahlmann, Neumakt (DE)

Correspondence Address: SCHIFF HARDIN & WAITE, 6600 SEARS TOWER, 233 S WACKER DR, CHICAGO, IL, 60606-6473, US

(21) Appl. No.: 10/172,539

(22) Filed: Jun. 13, 2002

(30) Foreign Application Priority Data
Jun. 13, 2001 (DE) 101 28 522.1

(51) Int. Cl. G06F 17/60

(52) U.S. Cl. 705/2

(57) ABSTRACT

In a method for a data processing facility to control and monitor the process sequence of a telemedical healthcare service which is to be provided. On the basis of at least one criterion, a service facility available for providing a particular subsidiary service of the healthcare service is automatically instructed by the central data processing facility to provide the particular subsidiary service. The central data processing facility then monitors whether the respective subsidiary service is provided and transmitted to the central data processing facility by the instructed service facility in good time on the basis of a time stipulation, and/or whether the respective subsidiary service provided satisfies a quality stipulation.

### BACKGROUND OF THE INVENTION

1. Field of the Invention

A method for controlling and monitoring the process sequence of a telemedical healthcare service.

2. Description of the Prior Art

In the course of the treatment and medical supervision of patients, telemedical healthcare services are becoming increasingly important. In this context, telemedical health services are understood to mean any type of telemedicine, for example the examination of medical data records which have been sent to a service facility for telemedical healthcare services via a communication network, or the online examination of body functions using technical means for the remote transmission of data. Telemedical healthcare services are thus preferably handled entirely, from placement of the instruction through performance to delivery of the result, using means for the remote transmission of data.

A healthcare service, which generally includes a number of subsidiary services, for example the recording of image data and the evaluation of image data, is normally not handled by a single service facility, which is to be understood, as an example, to mean registered doctors, that is to say resident doctors and specialists, clinics and special image-taking or examination centers. Instead, a telemedical healthcare service is normally provided by a number of such service facilities forming a healthcare service chain. The distribution of subsidiary services of the overall service which is to be provided as part of a telemedical healthcare service over various service facilities creates to the problem that, with service facilities which have a similar range of services, it is difficult for a control and supervisory body to decide which of the available service facilities is best suited for providing a subsidiary service of the telemedical healthcare service. Furthermore, it is frequently difficult to ascertain the current status of a telemedical healthcare service which is to be provided as well as the currently accountable center for providing an impending subsidiary service of the telemedical healthcare service. As a result responsibilities and accountabilities frequently cannot be defined and associated clearly, so there is a risk that constant high quality cannot be ensured when providing telemedical healthcare services.

U.S. Pat. No. 5,764,923 describes a method allowing colleagues at a medical service facility to classify patients seeking medical advice into various risk categories by using information tools without needing to provide a medical diagnosis in the process, in order subsequently to be able to convey to the patients a suitable medical treatment for their problem. On the basis of the category applicable to a patient and on the basis of the patient's needs, the time for medical treatment, a medical facility suitable for treating the patient and the type of treatment for the patient are recommended.

U.S. Pat. No. 5,835,897 describes a method which is intended to assist managers in the health service to be able to determine and compare the quality and price/performance ratio of service providers in the health service. In this case, patients are classified according to their illness and the treatment thereof. On the basis of this classification, the services of various service providers can be compared for treatment of the illness, and the best possible provider for treating the illness can be ascertained.

U.S. Pat. No. 5,867,821 discloses a communication system which has a “master library” storing a large amount of data, inter alia patient files, image data, laboratory data, pharmaceutical data, etc. These data can be accessed by various computers connected to the master library, the computers being associated with a ward within a hospital or with external doctors, for example.

U.S. Pat. No. 5,706,441 describes a method which can be used to ascertain a type of ranking list for medical service providers in a particular medical field with respect to the complexity of medical healthcare services which can be provided by the medical service providers. To this end, data records ascertained by various medical service providers for the treatment of a particular illness are put together and the individual cases are assessed according to the degree of difficulty of the treatment. Finally, this assessment can be used to indicate, for a provider of medical healthcare services whose medical healthcare services have been assessed, what degree of complexity of illness this medical healthcare service provider is capable of treating satisfactorily.

### SUMMARY OF THE INVENTION

An object of the present invention is to provide a method of the type initially described wherein it is simple for an instruction to be given to provide at least one subsidiary service of a telemedical healthcare service and for the provision of the subsidiary service to be monitored.

This object is achieved in accordance with the invention in a method for a central data processing facility to control and monitor the process sequence of a telemedical healthcare service which is to be provided and which can include one or more different subsidiary services, with a particular subsidiary service being able to be provided by a number of available service facilities which each have at least one computer available which can communicate with the central data processing facility via a communication network.

In the inventive method on the basis of at least one criterion, one of the service facilities available for providing a particular subsidiary service is automatically (or otherwise) instructed by the central data processing facility to provide the particular subsidiary service of the healthcare service so that, for a telemedical healthcare service with a number of subsidiary services, a chain of service facilities is automatically set up, each of which is accountable for providing a particular subsidiary service, and the provision of each subsidiary service by the respectively instructed service facility is automatically monitored by virtue of the central data processing facility monitoring whether the respective subsidiary service is transmitted from a computer in the respective service facility via the communication network to the central data processing facility in a timely manner on the basis of a time stipulation, and/or whether the respective subsidiary service provided satisfies a quality stipulation.

According to the invention, a central data processing facility which is connected to corresponding data processing facilities of service facilities in a healthcare service chain and undertakes the control function for the process sequence thus has at least one criterion, preferably a range of criteria, available according to which it is possible to stipulate accountabilities for providing at least subsidiary services of a telemedical healthcare service. In this case, the central data processing facility checks which service facilities and in which order these service facilities are suitable for providing the telemedical healthcare service, taking into account requirements expressed by an instructing party for the telemedical healthcare service and conditions imposed, and also taking into account service ranges which have been communicated by the service facilities or are available. Should it not be possible to break down a healthcare service to be provided into various subsidiary services, or should breakdown not be appropriate, the data processing facility uses at least one criterion to stipulate an accountable center for providing the overall service. This allows accountabilities for providing a telemedical healthcare service to be stipulated clearly, retrievably and traceably, so that there is a clear responsibility for providing an overall service or there are clear responsibilities for providing subsidiary services, with the targeted control of the process sequence for a healthcare service providing the prerequisites for ensuring a constantly high quality when providing telemedical healthcare services. In this case, the central data processing facility instructs service facilities to provide subsidiary services and monitors the process sequence for a telemedical health service which is to be provided to ensure the observance of time and/or quality stipulations for the healthcare service which is to be provided.

In one variant of the invention, a service facility instructed by the data processing facility needs to confirm acceptance of handling to the central data processing facility. If a service facility declines to provide a subsidiary service of the telemedical healthcare service or declines the overall service, the central data processing facility instructs a suitable alternative service facility to provide the overall or subsidiary services. This ensures that the healthcare service is actually provided and that no gap arises in the chain of subsidiary services which are to be provided. In this case, it is possible to trace not only the accountabilities but also the sequence of handling for providing subsidiary services of a telemedical healthcare service.

In one variant of the invention, the instruction is given to provide at least one subsidiary service of a telemedical healthcare service on the basis of a case-specific medical criterion. Such a criterion can be the case type to be handled, for example, the taking or evaluation of mammograms, magnetic resonance image sequences or the making of a histological incision. Another criterion of this kind can be a case object, such as which organ or body part needs to be examined. This type of criteria also includes the complexity of the case, the scope of the data to be processed by a service facility in the healthcare service chain, for example the scope of anamnesis data or the number of image data items, and also the quality of the data to be processed by a service facility in the healthcare service chain, particularly depending on whether the data delivered are to be evaluated manually or automatically and appropriate medical decisions are to be taken on the basis thereof. The case-specific criteria are thus central to establishing which service facility is actually able to provide the requested medical subsidiary service.

In a further variant of the invention, a criterion for instruction is the person or institution giving the instruction for the telemedical healthcare service. This involves taking into account the priority, for example the urgency assigned by the customer and the significance or importance of the customer. Another criterion is the sensitivity, i.e. whether providing the telemedical healthcare service gives rise to data with a very high secrecy level or data which need to be encrypted. Another criterion linked to the person or institution giving the instruction is the technical competence of the instructing party, such as whether the telemedical healthcare services are ordered by a renowned specialist clinic or by an unknown registered doctor.

In an embodiment of the invention, criteria for instruction are the type, scope and quality of the desired result. Accordingly, one criterion taken into account is whether an initial diagnosis is to be produced, whether a second opinion needs to be taken for a diagnosis which is already available, or whether a detailed expert report is requested.

In another embodiment of the invention, the instruction is recorded on the basis of colleague-specific or equipment-specific criteria. The colleague-specific criteria take account of the availability of operatives, their qualification and possibly their certification, that is to say whether they are renowned specialists or reliable colleagues, for example, and also the colleagues' workload, that is to say how many cases a colleague is already handling and the estimated time of delivery of a result. Likewise of significance for instruction are available tools and the technical equipment of a service facility so that satisfactory results can be expected for the provision of a telemedical healthcare service.

In a further embodiment of the invention, a criterion for instructing a service facility is a time stipulation. In this case, the criterion taken into account is the request or promised turnaround time for the telemedical healthcare service which is to be provided, and, in particular, whether the turnaround time necessitates work on a weekend or on holidays or even during nightshifts. In particular, time differences, holidays and different weekday structures need to be noted when service facilities in a healthcare service chain are distributed over different countries.

In one embodiment of the invention, the instruction can also be given on the basis of a technical criterion. Relevant criteria for this are the quality and speed of a telecommunications link for a data processing facility associated with a service facility, such as whether the service facility's data processing facility is connected to the healthcare service chain's central data processing facility, for example, by means of a modem or by means of a high-speed data link, for example. Other technical criteria are the utilization level of a service facility's systems which need to be used for providing a subsidiary service of a healthcare service, and also security requirements. When stipulating accountability, security requirements, particularly those concerning data transfer, demand a check to determine the extent to which the service facilities involved in handling a subsidiary service of a telemedical healthcare service are able to encrypt generated data, for example.

In another embodiment of the invention, the instruction can also be given on the basis of at least one financial criterion. This involves taking into account the costs arising within a service facility for the provision of a subsidiary service of a telemedical healthcare service, particularly for express work, and any cost limits prescribed by the instructing party.

In accordance with another embodiment of the invention, the instruction can also be given on the basis of legal criteria, such as the extent to which particular telemedical healthcare services are actually allowed to be provided in particular countries. It is also necessary to take into account data protection laws which are in place in the individual countries.

Other criteria for instruction can be the language in which the result of a telemedical healthcare service is to be communicated and also political and ethical aspects, with particular account needing to be taken of conflicts between nations and denominations. Another criterion for instruction can be the extent to which results of a telemedical healthcare service can be used further, be it for studies or for statistics. Thus, by way of example, healthcare services requiring medical services which are the subject of current studies can be given to service facilities which are performing the studies.

In one variant of the invention, an escalation process needs to be started in the event of time and/or quality stipulations not being observed. In the course of the escalation process, service facilities can be sent alarms indicating time delays or quality shortfalls in results of the subsidiary service requested. One variant of the invention provides. The escalation process can involve a change to the instruction to provide at least one subsidiary service of a healthcare service, for example to transfer instruction from a service facility which has not observed stipulations to another service facility.

In another embodiment of the invention, all the instructions and results which are attained in the course of providing a telemedical healthcare service are logged. This allows visualization of the process sequence, when providing a telemedical healthcare service, taking into account the instructions and results. Visualization can, as an example, take a form such that the entire process, i.e., all the service facilities in a healthcare service chain which together provide the telemedical healthcare service, is shown, with a distinction, for example by colored highlighting, between the subsidiary results already obtained and instructions, the current status and the service facilities which are yet to be used.

In this case, the logging makes it possible to define process measured variables, for example the handling time or quality stipulations, to ascertain them continuously or in the manner of random samples and to take the process measured variables as a basis for identifying weaknesses in the process sequence, and to eliminate these weaknesses by modifying the process sequence. It is thus also possible to certify the process on account of the traceable controls for the process.

### DESCRIPTION OF THE DRAWINGS

FIG. 1 shows four service facilities connected to a central data processing facility for the purpose of providing subsidiary services of a telemedical healthcare service in accordance with the invention.

FIG. 2 shows the visualization of a process sequence for the provision of a telemedical healthcare service in accordance with the invention.

### DESCRIPTION OF THE PREFERRED EMBODIMENTS

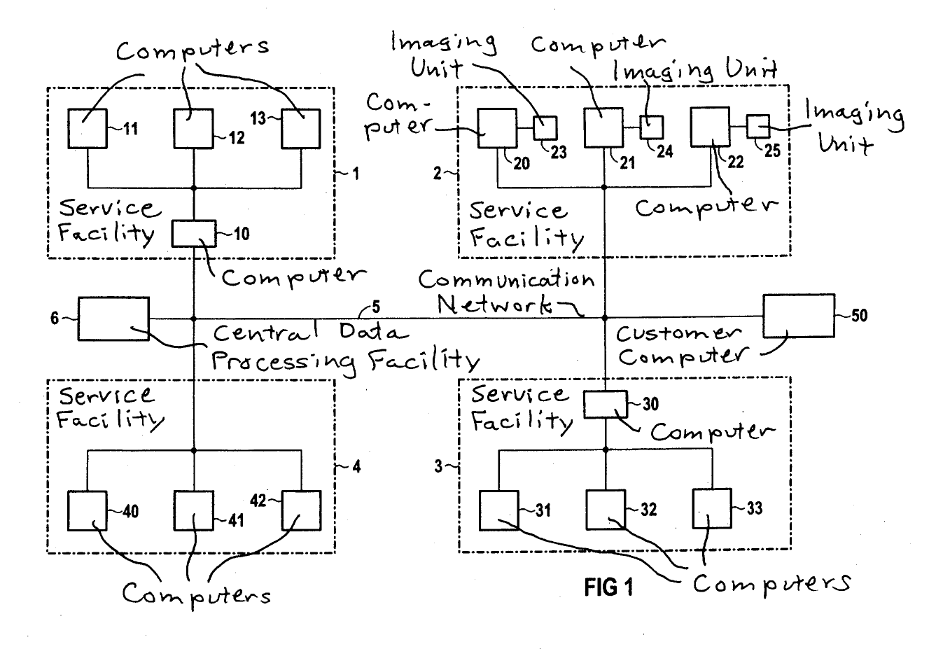

FIG. 1 shows, as an example, four service facilities 1 to 4 for providing subsidiary services of telemedical healthcare services and also a central data processing facility 6. In the exemplary embodiment, the central data processing 6 undertakes control and supervision of process sequences for telemedical healthcare services which are to be provided. To this end, computers in the healthcare facilities 1 to 4 are connected to the central data processing facility 6 via a communication network 5. In the exemplary embodiment, the control and supervision of such a process sequence is explained with reference to a telemedical healthcare service which involves the taking and evaluation of ophthalmological images.

The service facility 1 is used for obtaining ophthalmological images and has a computer 10 to which three units 11 and 13 for obtaining ophthalmological images are connected in the exemplary embodiment. The service facility 2 is likewise used for obtaining ophthalmological images and has computers 20 to 22. The computers 20 to 22 have respective units 23 to 25 connected thereto for obtaining ophthalmological images. The computers 20 to 22 are connected to the central data processing facility 6 directly via the communication network 5 and can communicate with said data processing facility 6. The service facility 3 has a computer 30 which is connected to the central data processing facility 6 directly via the communication network 5 and has three further computers 31 to 33 connected to it. The service facility 3 is used for evaluating ophthalmological images. The service facility 4 also is used for evaluating ophthalmological images, the service facility 4 having three computers 40 to 42 which are connected directly to the central data processing facility 6 via the communication network 5.

In the exemplary embodiment, the data processing facility 6 receives from a customer, for example from a patient or from a medical facility, the instruction to provide a telemedical healthcare service, which in the exemplary embodiment involves fundus images of the patient's eyes and evaluation of the images, at 10:00 on Jun. 5, 2001. The instruction is sent to the data processing facility 6 from a computer 50 associated with the customer by email. The customer wishes to have the result of the evaluation delivered to him no later than at 15.00 on Jun. 8, 2001 and in German. The customer makes no particular requests regarding the type, scope and quality of the result, but rather wishes to have the cheapest possible initial examination of fundus images. The data processing facility 6 now has the task of selecting from the service facilities 1 to 4, which are available for providing such a telemedical healthcare service, those which are best suited to providing the telemedical healthcare service, taking into account the customer's requirements, and of declaring them accountable. Finally, the data processing facility 6 uses a range of criteria to stipulate the accountabilities for providing subsidiary services of the healthcare service. The data processing facility 6 first uses case-specific criteria to check which of the service facilities is suitable for taking the fundus image. For this task, the data processing facility 6 has the service facilities 1 and 2 available in the case of the exemplary embodiment.

Since the customer is a normal customer, the criteria to be taken into account for stipulating accountability do not need to be any special person-specific or institution-specific criteria which might require particularly high-priority or sensitive handling. As regards the type, scope and quality of the desired result, no special criteria need to be taken into account in this respect either. As already mentioned, the customer wishes to have an initial examination of the fundus images.

With regard to colleague-specific and equipment-specific criteria, the data processing facility 6 checks which of the service facilities 1 and 2 is able to take the fundus images. In the exemplary embodiment, the data processing facility 6 uses the computer 10 in the service facility 1 to ascertain the utilization level of the units 11 to 13 and also the availability of the people operating the units 11 to 13 for the next three days. In the exemplary embodiment, the enquiry reveals that the fundus images can be taken using the unit 12 between 10.00 and 12.00 on Jun. 6, 2001. In the case of the service facility 2, the data processing facility 6 can ascertain the availability of the units 23 to 25 and the availability of the people operating the units 23 to 25 directly by means of an enquiry sent to the computers 20 to 22 for the units 23 to 25. From the response of the computers 20 to 22, the data processing facility 6 registers that the fundus images can be taken between 15:00 and 16:00 on Jun. 6, 2001 both using the unit 21 and using the unit 22.

With regard to technical criteria, such as the quality and speed of the communications link and also security requirements, the service facilities 1 and 2 have the same quality level. Taking into account financial criteria, particularly the customer's desire for inexpensive provision of the healthcare service, reveals that the fundus images are cheaper when the service facility 1 is instructed than when the service facility 2 is instructed. Other criteria, relating to legal aspects, the language used, political and ethical aspects and also aspects regarding the possibility of further case evaluations, do not need to be taken into account for fundus images in the case of the present exemplary embodiment.

The cheaper production of the fundus images means that the data processing facility 6 therefore instructs the service facility 1 to produce the fundus images for the customer at 10:00 on Jun. 6, 2001 and to send the fundus images to the data processing facility 6 by 13:00 on Jun. 6, 2001. In the exemplary embodiment, the computer 10 in the service facility 1 confirms acceptance of the instruction to the data processing facility 6, which informs the customer and summons him to the service facility 1 for 10:00 on Jun. 6, 2001 in order for the images to be taken. The customer can be informed, for example, by the data processing facility 6 sending an email with appropriate content to the customer's computer 50 via the communication network 5. Should the customer not be able to make this appointment, which is not the case in the present example, the data processing facility 6 ascertains an alternative appointment and notifies the customer of this appointment.

In a second step, the data processing facility 6 stipulates, among the service facilities 1 to 4 available for handling the telemedical healthcare service, the accountability for evaluating the fundus images according to suitability for this task. Taking into account the case-specific criterion, evaluation of fundus images for eyes, the two service facilities 3 and 4 are available for this purpose. Since the customer is a normal person, as already mentioned, for whom no special priorities and sensitivities need to be taken into account, personal criteria are of no significance for stipulating the accountability for evaluating the fundus images either. Since the evaluation is an initial evaluation of fundus images, no particular criteria need to be taken into account in this respect either.

With regard to the colleague-specific and equipment-specific criteria, the data processing facility 6 contacts the computer 30 in order to ascertain which of the computers 31 to 33, associated with the people, is available to evaluate fundus images between 14:00 on Jun. 6, 2001 and 12:00 on Jun. 8, 2001. The computer 30 signals to the data processing facility 6 that the computer 32 is available for such evaluation between 09:00 and 11:00 on Jun. 7, 2001. For the service facility 4, the data processing facility 6 can request the availability of the computers 40 to 42, associated with people, directly, the computer 42 being available for an evaluation between 10:00 and 12:00 on Jun. 7, 2001.

With regard to technical criteria, financial and legal aspects, there is no difference between the service facilities 3 and 4 in the exemplary embodiment. Such criteria are thus of no significance in the exemplary embodiment. However, for the evaluation, it is necessary to take into account a language criterion, since the customer wishes to receive the evaluation and the medical decisions taken on the basis of the evaluation in German. In the exemplary embodiment, the service facility 3 is able to supply the evaluation and the medical decisions taken on the basis thereof only in English on account of the short notice, however, by reason of which the service facility 3 is not suitable for evaluating the fundus images. Since no other political and ethical criteria, or criteria which affect the opportunities for further case evaluations, oppose instructing the service facility 4, the data processing facility 6 finally signals to the service facility 4, specifically to the computer 42 in the service facility 4, that it or the person operating this computer is accountable for evaluating the fundus images. The evaluation of the fundus images needs to be sent to the data processing facility 6 by 14:00 on Jun. 7, 2001. In the exemplary embodiment, the computer 42 signals its accountability, that is to say that it accepts the instruction, to the data processing facility 6. Accordingly, the data processing facility 6 has used a range of criteria for obtaining fundus images and for evaluating fundus images to stipulate accountabilities clearly such that they can be retrieved and traced. In this case, the healthcare service chain for providing this telemedical healthcare service includes the service facility 1 and the service facility 4.

Following stipulation of accountabilities, the data processing facility 6 automatically monitors whether the fundus images are taken by the service facility 1 at the predetermined time on Jun. 6, 2001 by virtue of the data processing facility 6 sending corresponding queries to the computer 10 in the service facility and monitoring whether the fundus images arrive at the data processing facility 6 at the requested time. In the case of the present exemplary embodiment, the fundus images are produced within the service facility 1 and transmitted to the data processing facility 6 at the prescribed time. When they have been received, the data processing facility 6 automatically checks the quality of the fundus images using a checking program. In this case, the data processing facility 6 ascertains parameters which characterize the image quality, such as image brightness and contrast, and compares these with quality stipulations. If, as in the exemplary embodiment, the image quality matches the stipulations, the data processing facility 6 transmits the fundus images to the computer 42 in the service facility 4 for the purpose of evaluating the fundus images and monitors whether the fundus images are evaluated within the time stipulation. Had the data processing facility 6 discovered quality shortfalls in the fundus images, the fundus images would have had to have been taken again, which would have required another accountability to have been stipulated and an appointment to have been agreed with the customer.

In the exemplary embodiment, absence of the person operating the computer 42 means that the fundus images are not evaluated until 14:00 on Jun. 7, 2001. Hence, when no evaluation has been transmitted, the data processing facility 6 starts an escalation process in order to observe the time frame prescribed by the customer, said escalation process involving, in the exemplary embodiment, a check to determine who can evaluate the fundus images at short notice. For evaluations at short notice, the service facility 4 has an available person, operating the computer 40, who preferably handles high-priority cases. High-priority cases are involved when an evaluating center is overtaxed with the evaluation on account of an unforeseen complexity in the case, or when, as in the present case, a critical deadline has not been observed. In the exemplary embodiment, there are thus different levels of competence within the service facility 4, which may also be the case in the other service facilities.

The data processing facility 6 thus instructs the computer 40 or the person operating the computer 40 to evaluate the fundus images which have not yet been evaluated as soon as possible and to transmit them to the data processing facility 6 by no later than 18:00 on Jun. 7, 2001. In the exemplary embodiment, the person operating the computer 40 accepts the instruction to evaluate the fundus images, which means that the accountability has changed, and this is registered within the data processing facility 6. Finally, the person associated with the computer 40 evaluates the fundus images, infers medical decisions and sends a corresponding report to the data processing facility 6 in good time. The data processing facility 6 produces an overall report containing the fundus images and the evaluation and the medical decisions taken on the basis thereof and sends the overall report to the instructing customer by 15:00 on Jun. 8, 2001.

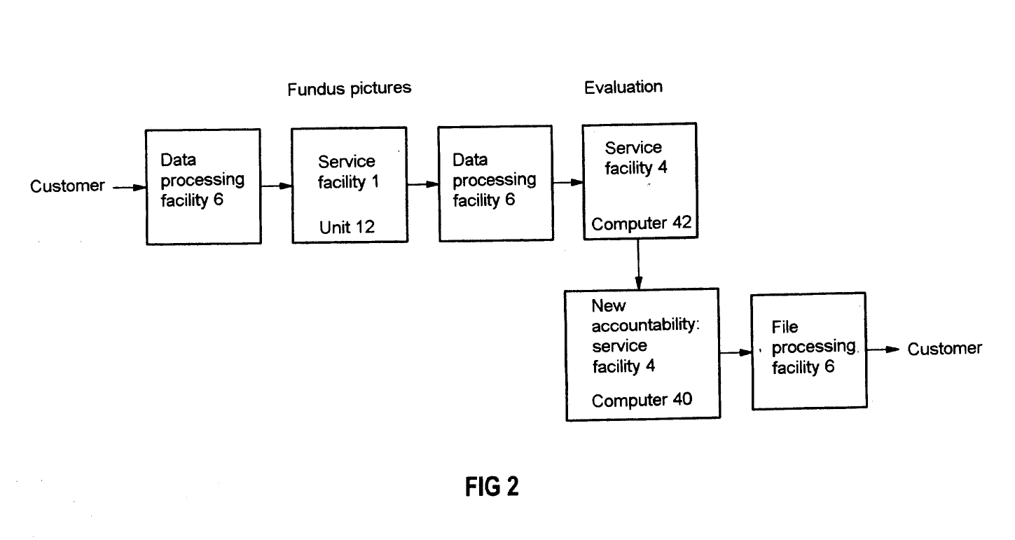

In this case, in the course of handling of the telemedical healthcare services, the data processing facility 6 logs and stores all accountabilities, the change of accountabilities and all the subsidiary results obtained in the service facilities 1 and 4, so that the process sequence can be visualized using visualization software. Such visualization is shown in FIG. 2 for the telemedical healthcare service explained. FIG. 2 shows that the fundus images have been produced in the service facility 1 using the unit 12 and have been forwarded to the computer 42 in the service facility 4 via the data processing facility 6. On account of the person who operates the computer 42 having been absent at short notice, the accountability has changed to the person operating the computer 40, who evaluated the fundus images and sent the result of the evaluations to the data processing facility 6. Finally, the data processing facility 6 has produced the overall report and has sent it to the customer.

The inventive method has been described above using the example of taking and evaluating fundus images. The method is not limited to controlling such a healthcare service, however. Instead, the method can also be used for controlling telemedical healthcare services in which only an overall service needs to be provided or in which more than two subsidiary services need to be provided. In this case, the healthcare services do not need to involve or be limited to the taking and evaluation of images.

Otherwise, the stipulation of accountabilities does not necessarily have to be made dependent on the checking of an entire range of criteria. Instead, the checking of just one fundamental criterion for stipulating an accountability can also be sufficient.

In addition, a service facility does not necessarily need to confirm an accountability explicitly. Confirmation can also be in the performance of a subsidiary service or overall service.

Unlike in the exemplary embodiment described above, an escalation process does not need to involve the accountability for providing a service being changed immediately. Instead, a service facility which has got behind with a service can have the delay indicated to it in the form of an alarm signal, and a new time for providing the service can be prescribed or agreed. The accountability would only be changed if the new time were also not observed. In this case, accountabilities can be changed within service facilities or between service facilities.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for a central data processing facility to control and monitor a process sequence of a telemedical healthcare service which is to be provided and which comprises different subsidiary services, with a particular subsidiary service being able to be provided by a plurality of available service facilities each having at least one computer available which can communicate with the central data processing facility via a communication network, said method comprising the steps of:
on the basis of at least one criterion, automatically instructing one of the service facilities available for providing a particular subsidiary service by the central data processing facility to provide the particular subsidiary service of the healthcare service and thereby automatically setting up a chain of service facilities of said telemedical healthcare service, each of which is accountable for providing a particular subsidiary service; and
automatically monitoring the provision of each subsidiary service by the respectively instructed service facility by the central data processing facility monitoring at least one of whether the respective subsidiary service is transmitted from a computer in the respective service facility via the communication network to the central data processing facility within a time dependent on a time stipulation, and whether the respective subsidiary service provided satisfies a quality stipulation.

2. A method as claimed in claim :1, comprising requiring the instructed service facility to confirm acceptance of said handling.

3. A method as claimed in claim 1 comprising providing the instruction dependent on a case-specific medical criterion.

4. A method as claimed in claim 1 comprising providing the instruction dependent on a person or institution initiating the telemedical healthcare service as a criterion.

5. A method as claimed in claim 1 comprising providing the instruction dependent on a type, scope and quality of the desired result as a criterion.

6. A method as claimed in claim 1 comprising providing the instruction dependent on colleague-specific or equipment-specific criteria.

7. A method as claimed in claim 1 comprising providing the instruction dependent on said time stipulation.

8. A method as claimed in claim 1 comprising providing the instruction dependent on a technical criterion.

9. A method as claimed in claim 1 comprising providing the instruction dependent on a financial criterion.

10. A method as claimed in claim 1 comprising providing the instruction dependent on a legal criterion.

11. A method as claimed in claim 1 comprising providing the instruction dependent on a language in which a result of the telemedical healthcare service is to be communicated.

12. A method as claimed in claim 1 comprising providing the instruction dependent on one of a political or ethical criterion.

13. A method as claimed in claim 1 comprising providing the instruction dependent on an opportunity for further use of a result of the telemedical healthcare service.

14. A method as claimed in claim 1 comprising initiating an escalation process if said one of said time and quality stipulations is not satisfied.

15. A method as claimed in claim 14, comprising, in the escalation process, changing the instruction to provide at least one subsidiary service of the healthcare service.

16. A method as claimed in claim 1 comprising logging all of said instructions and results which are attained in the course of providing the telemedical healthcare service.

17. A method as claimed in claim 1 comprising providing a visualization of the process sequence dependent on the instructions and attained results.

18. A method as claimed in claim 16 comprising ascertaining process-measured variables dependent on the logging.
